(19) United States
(12) Patent Application Publication
(10) Pub. No.: US 2016/0321024 A1
(43) Pub. Date: Nov. 3, 2016

(54) DISPLAY DEVICE, RELATED TRANSPORTATION DEVICE, AND RELATED METHOD

(71) Applicant: Samsung Display Co., Ltd., Yongin-City (KR)

(72) Inventors: You Young JIN, Suwon-si (KR); Jung Suk BANG, Seoul (KR); Wang Su HONG, Hwaseong-si (KR)

(21) Appl. No.: 14/933,617

(22) Filed: Nov. 5, 2015

(30) Foreign Application Priority Data
Apr. 28, 2015 (KR) 10-2015-0060004

(51) Int. Cl. G06F 3/14; G06F 1/16; B60R 11/02

(52) U.S. Cl. CPC G06F 3/1446; B60R 11/0229; G06F 1/1601; B60R 2011/0288; B60R 2011/0028

(57) ABSTRACT

A display device may include a first display apparatus, a second display apparatus, and a guide mechanism. The guide mechanism may be connected to each of the first display apparatus and the second display apparatus and may guide each of movement of the first display apparatus and movement of the second display apparatus.

### CROSS-REFERENCE TO RELATED APPLICATION

This application claims priority to and the benefit of Korean Patent Application No. 10-2015-0060004 filed in the Korean Intellectual Property Office on Apr. 28, 2015; the entire contents of the Korean Patent Application are incorporated herein by reference.

### BACKGROUND

(a) Technical Field

The technical field relates to a display device, a transportation device that includes the display device, and a method of operating the display device.

(b) Description of Related Art

A display device may be installed at a predetermined location inside a transportation device. A passenger riding the transportation device may view images displayed by the display device.

The above information disclosed in this Background section is for enhancement of understanding of the background of this application. This Background section may contain information that does not form the prior art that is already known in this country to a person of ordinary skill in the art.

### SUMMARY

An embodiment may be related to a display device. The display device may include a first display apparatus, a second display apparatus, and a guide mechanism. The guide mechanism may be connected to each of the first display apparatus and the second display apparatus and may guide each of movement of the first display apparatus and movement of the second display apparatus.

An embodiment may be related to a transportation device. The transportation device may include the following elements: a ceiling; a first seat positioned below the ceiling; a first display apparatus; a second display apparatus; and a guide mechanism connected to each of the first display apparatus and the second display apparatus and configured to guide movement of at least one of the first display apparatus and the second display apparatus relative to at least one of the ceiling and the first seat.

The first display apparatus may be positioned on the ceiling in a first mode of the first display apparatus. The first display apparatus may be positioned to face a center portion of the first seat in a second mode of the first display apparatus.

The first display apparatus may be positioned to face a first side portion of the first seat in a third mode of the first display apparatus. The second display apparatus may be positioned on the ceiling in a first mode of the second display apparatus. The second display apparatus may be positioned to face a second side portion of the first seat in a second mode of the second display apparatus.

The first display apparatus and the second display apparatus may abut each other in the second mode of the second display apparatus.

The first display apparatus and the second display apparatus may both be curved in the second mode of the second display apparatus.

The transportation device may include a third display apparatus. The third display apparatus may be positioned on the ceiling in a first mode of the third display apparatus. The third display apparatus may be positioned to face the center portion of the first seat in a second mode of the third display apparatus.

The second display apparatus may be oriented at an obtuse angle with respect to the first display apparatus in a top view of the transportation device (e.g., in the second mode of the second display apparatus). The transportation device may include a third display apparatus. The third display apparatus may be oriented may be a mirror image of the second display apparatus with reference to the first display apparatus in a top view of the transportation device (e.g., in the second mode of the second display apparatus).

The transportation device may include a housing member that holds and directly contacts each of the first display apparatus and the second display apparatus. A first portion of the housing member may be slanted or perpendicular with respect to the ceiling. A second portion of the housing member may be positioned on the ceiling (and may be parallel to the ceiling). The first portion of the housing member may directly contact the first display apparatus. The second portion of the housing member may directly contact the second display apparatus. The first portion of the housing member may be slanted or perpendicular with respect to the second portion of the housing member (in a side view of the transportation device).

The transportation device may include a rear window. The first display apparatus may be positioned on the ceiling in a first mode of the first display apparatus. The first display apparatus may be positioned between the first seat and the rear window in a second mode of the first display apparatus.

The transportation device may include a rear window. The first display apparatus may be positioned on the ceiling in a first mode of the first display apparatus. The first seat may be positioned between the first display apparatus and the rear window in a second mode of the first display apparatus. The first display apparatus may be positioned between the first seat and the rear window in a third mode of the first display apparatus.

The transportation device may include a second seat. The first display apparatus may be positioned on the ceiling in a first mode of the first display apparatus. The first seat may be positioned between the first display apparatus and the second seat in a second mode of the first display apparatus. The second display apparatus may be positioned on the ceiling in a first mode of the second display apparatus. The second seat may be positioned between the second display apparatus and the first seat in a second mode of the second display apparatus.

An embodiment may be related to method of operating a display device. The method may include moving, using a guide mechanism, a first display apparatus of the display device downward from a ceiling of a transportation device. The method may include positioning, using the guide mechanism, the first display apparatus of the display to face a first portion (e.g., a center portion) of a first seat of the transportation device. The first seat of the transportation device may be positioned below the ceiling of the transportation device.

The method may include rotating the first display apparatus after the first display apparatus has become slanted or perpendicular with respect to the ceiling, such that an image display side of the first display apparatus faces the first seat.

The method may include moving, using the guide mechanism, a second display apparatus of the display device downward from the ceiling of the transportation device. The method may include moving, using the guide mechanism, the second display apparatus of the display device sideways to face a second portion (e.g., a side portion) of the first seat of the transportation device.

The method may include positioning, using the guide mechanism, the first display apparatus of the display device or a second display apparatus of the display device between the first seat of the transportation device and a rear window of the transportation device.

The method may include moving, using the guide mechanism, one of the first display apparatus of the display device and a second display apparatus of the display device to position a second seat of the transportation device between a third seat of the transportation device and the one of the first display apparatus of the display device and the second display apparatus of the display device.

An embodiment may be related to a display device that include the following elements: two or more display apparatuses, wherein a display apparatus of the display apparatuses may include a flexible substrate and a plurality of pixels formed on the flexible substrate; a housing that supports the display apparatuses; and a guide member configured to guide movement of the housing within a predetermined distance range.

An embodiment may be related to a vehicle that includes the display device.

A first part of the guide member may extend in a longitudinal direction of the vehicle on a bottom surface of a vehicle ceiling of the vehicle, and a second part of the guide member may extend downward from the vehicle ceiling.

The display apparatuses may be installed on the bottom surface of the vehicle ceiling through the housing, a sliding member, and the guide member. The display apparatuses may include the following items: a first display apparatus; a second display apparatus abutting the first display apparatus; and a third display apparatus abutting the second display apparatus or the first display apparatus.

A part of the guide member vertically extends toward a back seat space of the vehicle from the vehicle ceiling.

The first display apparatus, the second display apparatus, and/or the third display apparatus may be positioned in the rear seat space of the vehicle through the guide member.

Two or more of the first display apparatus, the second display apparatus, and the third display apparatus are continuously positioned in a traverse direction (i.e., crosswise direction) of the vehicle in the back seat space.

A part of the guide member extends toward a rear window of the vehicle from the vehicle ceiling.

At least one of the first display apparatus, the second display apparatus, and the third display apparatus may be positioned on the rear window through the housing and/or the guide member, so that an image display side of the at least one display apparatus faces the rear window of the vehicle.

A part of the guide member (horizontally) extends toward a position at the left side of a driver's seat.

One of the first display apparatus, the second display apparatus, and the third display apparatus is positioned at the left side of the driver's seat through the guide member.

The display apparatus positioned at the left side of the driver's seat is electrically connected to a rear camera or a side camera of the vehicle.

A part of the guide member (horizontally) extends toward a position at a right side of a passenger seat.

One of the first display apparatus, the second display apparatus, and the third display apparatus is positioned at the right side of the passenger seat through the guide member.

The display apparatus positioned in the space at the right side of the passenger seat is electrically connected to a rear camera or a side camera of the vehicle.

The display apparatuses may include one or more of a transparent panel, a flat panel, and a flexible panel.

Advantageously, embodiments may provide enlarged, three-dimensional images to passengers inside a transportation device by consecutively arranging display panels or display apparatuses. Embodiments may optimize passengers' image viewing experience by optimally sizing, positioning, and orienting display apparatuses inside a transportation device. Embodiments may display images to people positioned outside a transportation device using one or more display apparatuses positioned inside the transportation device. Embodiments may enhance safety of a transportation device by providing enhanced images related to the surroundings to the driver of the transportation device.

### BRIEF DESCRIPTION OF THE DRAWINGS

FIG. 1 is a cross-sectional view of a display apparatus according to an embodiment.

FIG. 2 is a diagram schematically illustrating a display device, a related transportation device, and a related method according to an embodiment.

FIG. 3 is a diagram schematically illustrating a display device, a related transportation device, and a related method according to an embodiment.

FIG. 4 is a diagram schematically illustrating a display device and a related method according to an embodiment.

FIG. 5 is a diagram schematically illustrating a display device and a related method according to an embodiment.

FIG. 6 is a diagram schematically illustrating a display device, a related transportation device, and a related method according to an embodiment.

FIG. 7 is a diagram schematically illustrating a display device, a related transportation device, and a related method according to an embodiment.

FIG. 8 is a diagram schematically illustrating a display device, a related transportation device, and a related method according to an embodiment.

### DETAILED DESCRIPTION OF THE EMBODIMENTS

Some embodiments are described with reference to the accompanying drawings. As those skilled in the art would realize, the described embodiments may be modified in various ways.

Although the terms “first”, “second”, etc. may be used herein to describe various elements, these elements should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used to differentiate different categories or sets of elements. For conciseness, the terms “first”, “second”, etc. may represent, for example, “first-category (or first-set)”, “second-category (or second-set)”, etc., respectively.

In the drawings, thicknesses of layers, films, panels, regions, etc., may be exaggerated for clarity. Like reference numerals may designate like elements in this application. When a first element such as a layer, film, region, or substrate is referred to as being “on” a second element, the first element can be directly on the other element, or one or more intervening elements may also be present. In contrast, when a first element is referred to as being “directly on” a second element, there are no intervening elements intentionally provided between the first element and the second element.

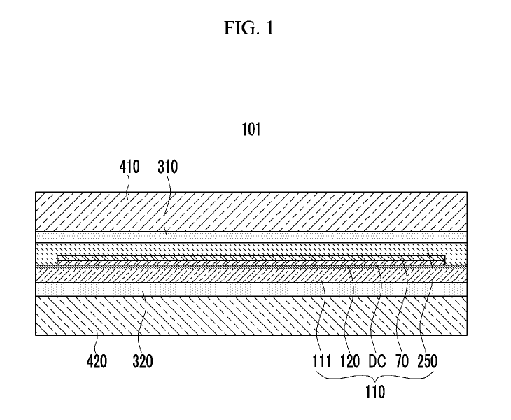

FIG. 1 is a cross-sectional view of a display apparatus 101 according to an embodiment.

As illustrated in FIG. 1, the display apparatus 101 includes a flexible display panel 110, a first protective film 410, a first adhesive 310, a second protective film 420, and a second adhesive 320.

The flexible display panel 110 includes a flexible substrate 111, a driving circuit unit DC, a plurality of pixels 70, and an encapsulation thin film 250. The flexible display panel 110 may be one of an organic light emitting display panel, a liquid crystal panel, and an electrophoretic display panel.

The flexible substrate 111 is made of one or more of a flexible plastic material, a metallic material (e.g., stainless steel), etc. One or more other flexible materials may be used for the flexible substrate 111.

The driving circuit unit DC includes thin film transistors. The plurality of pixels 70 is connected to the driving circuit unit DC and may emit light according to driving signals received from the driving circuit unit DC so as to display an image.

The encapsulation thin film 250 may have a multi-layered structure. The encapsulation thin film 250 may include at least one inorganic layer and/or at least one organic layer.

The flexible display panel 110 further includes a barrier layer 120 disposed between the flexible substrate 111 and the driving circuit unit DC. The barrier layer 120 may include two or more layers, such as inorganic layers and organic layers. The barrier layer 120 prevents unwanted substances (such as moisture) from passing through the flexible substrate 111 and permeating the pixels 70.

The first protective film 410 overlaps the encapsulation thin film 250. The first adhesive 310 is disposed between the first protective film 410 and the encapsulation thin film 250. The first protective film 410 is attached to the encapsulation thin film 250 through the first adhesive 310.

The second protective film 420 overlaps the flexible substrate 111. The second adhesive 320 is disposed between the second protective film 420 and the flexible substrate 111. The second protective film 420 is attached to the flexible substrate 111 through the second adhesive 320.

The first protective film 410 and the second protective film 420 may improve mechanical strength of the flexible display panel 110. The first protective film 410 and the second protective film 420 may be made of a plastic material and have a flexible characteristic like the flexible substrate 111.

The first protective film 410 and/or the second protective film 420 may include one or more polarization films for performing polarization. In an embodiment, the pixels 70 are top emission pixels that emit light toward the first protective film 410 to display an image, and the first protective film 410 may have a polarization function. In an embodiment, the pixels 70 are bottom emission pixels that emits light toward the second protective film 420 to display an image, and the second protective film 420 may have a polarization function. In an embodiment, the pixels 70 are double-sided emission pixels, and both of the first protective film 410 and the second protective film 420 may perform polarization. In an embodiment, neither of the first protective film 410 and the second protective film 420 may perform polarization.

A thickness of the flexible display panel 110 except the flexible substrate 111 may be several micrometers. The flexible substrate 111 may have a thickness of only several tens of micrometers.

The first protective film 410 and the second protective film 420 may improve mechanical strength of the flexible display panel 110 and may prevent damage to the flexible display panel 110. The protective films may have different elastic coefficients and/or different portions at different locations, depending locations where the flexible display panel 110 is bent, thereby improving flexibility of the display apparatus 101.

A shape and/or movement of the flexible display apparatus 101 may be maintained and/or guided using a housing member and/or a guide member. A display device may include the display apparatus 101, the guide member, and/or the housing. A transportation device, such as a vehicle, may include the display apparatus 101, the guide member, and/or the housing.

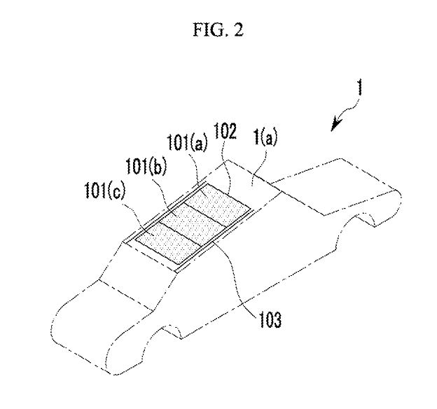

FIG. 2 is a diagram schematically illustrating a display device, a related transportation device (e.g., a vehicle 1), and a related method according to an embodiment.

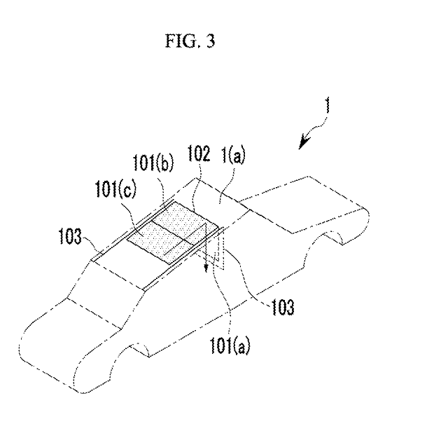

Referring to FIG. 2, the vehicle 1 may include a display device that includes a guide mechanism 102 (or guide member 102), a housing 103, and two or more display apparatuses, e.g., display apparatuses 101a, 101b, and 101c, including flexible display panels. A structure of each of the apparatuses 101a, 101b, and 101c may be analogous to the structure of the flexible display panel 110 and/or a structure of the display apparatus 101 discussed with reference to FIG. 1. In an embodiment, the two or more display apparatuses are consecutively mounted along a surface (e.g., a curved surface) of the vehicle ceiling 1a. The housing 103 may partially or completely contain the display apparatuses and may move the display apparatuses using a sliding member (not illustrated) along the guide member 102, which is attached to the vehicle ceiling 1a. The guide member 102 may guide and limit movement of the apparatuses. In an embodiment, when the display device is not used by any passengers in the vehicle 1, the display apparatuses are guided to the vehicle ceiling 1a, as illustrated in FIG. 2; when a passenger would like to use the display device, one or more of the display apparatus may be moved according to a position of the passenger in the vehicle, as illustrated in FIG. 3. Advantageously, space utilization of the vehicle 1 and the passenger's image viewing experience may be optimized.

FIGS. 3 to 5 are diagrams schematically illustrating the display device, the vehicle 1, and related methods according to an embodiment.

Referring to FIG. 3, the display apparatuses may be moved forward to expose the display apparatus 101a in front of a seat inside the vehicle to be viewed by a passenger.

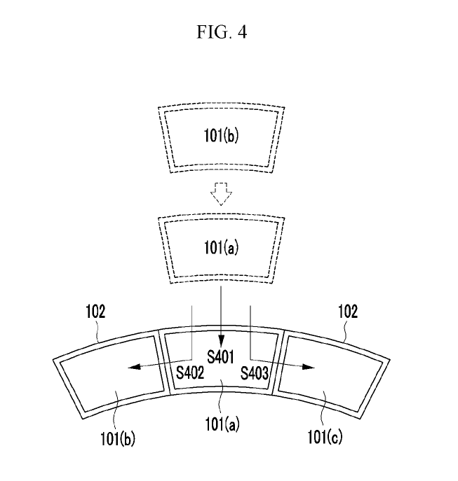

In an embodiment, referring to FIG. 4, the first display apparatus 101a may be moved downward from the vehicle ceiling 1a to a central region in front of a back seat (in a step S401). The second display apparatus 101b may be moved downward from the vehicle ceiling compartment 1a to the central region in front of the back seat and then moved to the left with respect to the first display apparatus 101a (in a step S402). The third display apparatus 101c may be moved downward from the vehicle ceiling 1a to the central region in front of the back seat and then moved to the right with respect to the first display apparatus 101a (in a step S403).

In this case, as illustrated in FIG. 4, movement distances of the second display apparatus 101b and the third display apparatus 101c, which are moved horizontally, may be configured so that display screens of the second display apparatus 101b, the first display apparatus 101a, and the third display apparatus 101c are connected in a horizontal direction.

The guide member 102 and the sliding member (not illustrated) may determine paths and positions of the display apparatuses 101.

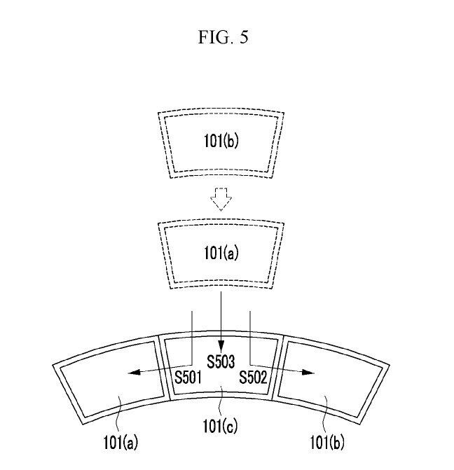

In an embodiment, referring to FIG. 5, the first display apparatus 101a may be moved downward from the vehicle ceiling 1a to the central region in front of the back seat and then moved in the left or right direction (in a step S501). The second display apparatus 101b may be moved downward from the vehicle ceiling 1a to the central region in front of the back seat and then moved in the right or left direction that is opposite to that of the first display apparatus 101a (in a step S502). The third display apparatus 101c may be moved downward from the vehicle ceiling 1a to the central region in front of the back seat so as to be positioned between the first display apparatus 101a and the second display apparatus 101b (in a step S503).

In an embodiment, as illustrated in FIG. 5, movement distances of the first display apparatus 101a and the second display apparatus 101b, which are moved horizontally, may be adjusted so that display screens of the first display apparatus 101a, the third display apparatus 101c and the second display apparatus 101b are connected in a horizontal direction.

The guide member 102 and the sliding member (not illustrated) may determine paths and positions of the display apparatuses.

The first display apparatus 101a, the second display apparatus 101b, and the third display apparatus 101c may display divided images and may collectively display a supersized combined image. in a top view of the vehicle 1, the display apparatuses disposed at the left and the right with respect to the display apparatus positioned at the center may be oriented at predetermined angles (e.g., predetermined obtuse angles) with respect to the display apparatus positioned at the center, thereby providing a seemingly stereoscopic and/or panorama image. In an embodiment, each of the display apparatuses 101a, 101b, and 101c may be curved in front of the back seat, thereby providing a three-dimensional viewing experience to the passenger.

In an embodiment, one or more display apparatus are moved from the vehicle ceiling to one or more positions in front of the back seat to be viewed by a first passenger, and one or more display apparatuses remain on the ceiling 1a without obstructing a second passenger's sight.

In an embodiment, one or more of the display apparatuses may be rotated after being moved down from the ceiling 1a, for providing one or more suitable viewing angles. The rotation may be performed about an axis substantially perpendicular or parallel to a bottom of the vehicle 1. In an embodiment, the display sides of the display apparatuses may face upward when the display apparatuses are in the stowed position on the ceiling 1a, and the display apparatuses may be rotated by 180 degrees after descending from the ceiling 1a, such that the display sides may face the back seat passenger.

The sliding member (not illustrated) may be mounted on a rear surface of the housing 103. The sliding member may be compressible and extensible for facilitating sliding movement of the housing 103 ceiling and/or the display apparatuses.

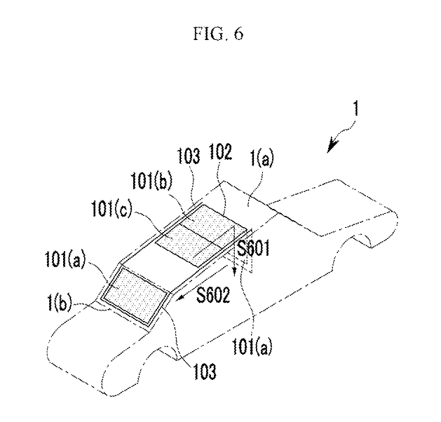

FIG. 6 is a diagram schematically illustrating the display device, the vehicle 1, and a related method according to an embodiment.

Referring to FIGS. 3 and 6, at least one of the display apparatuses, e.g., the display apparatus 101a, may be moved to a rear window 1b of the vehicle 1 using the guide member 102 for displaying images to viewers outside the vehicle 1.

In an embodiment, the first display apparatus 101a is moved downward from the vehicle ceiling 1a to an position in front of a back seat (in a step S601) and then moved to the rear window 1b behind the back seat (in a step S602). In an embodiment, the first display apparatus 101a may be attached to the rear window 1b with a display side facing outside.

FIG. 6 illustrates that the second display apparatus 101b and the third display apparatus 101c are moved along with the first display apparatus 101a. In an embodiment, the second display apparatus 101b and the third display apparatus 101c are not moved when the first display apparatus 101a is moved.

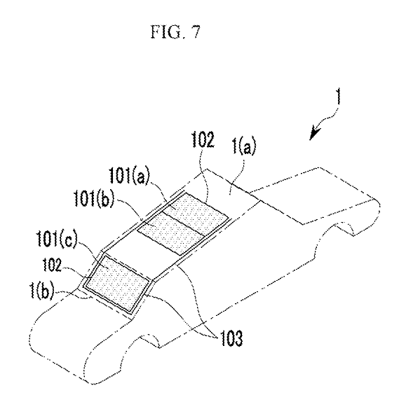

FIG. 7 is a diagram schematically illustrating the display device, the vehicle 1, and a related method according to an embodiment.

Referring to FIGS. 3 and 7, the third display apparatus 101c is moved in a sliding manner from the vehicle ceiling 1a to the rear window 1b. In an embodiment, the third display apparatus 101c is attached to the rear window 1b so as to display images to viewers outside the vehicle 1.

The display device of the vehicle 1 may advantageously display images to people outside the vehicle 1 for providing traveling information, emergency stop signals, road condition information, traffic information, and/or information related a state of the vehicle passenger.

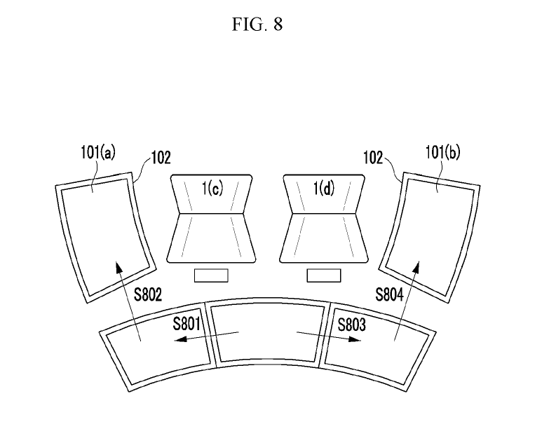

FIG. 8 is a diagram schematically illustrating the display device, the vehicle 1, and a related method according to an embodiment.

Referring to FIGS. 3 and 8, at least one of the display apparatuses is moved downward from the vehicle ceiling 1a to a position in front of the back seat and then moved to a side of a front seat of the vehicle 1 so as to be disposed on a side window of the vehicle. For example, as illustrated in FIG. 8, the first display apparatus 101a is moved downward from the vehicle ceiling 1a to a position behind a driver's seat 1c (in a step S801) and then moved to a position at the left of the driver's seat 1c (in a step S802). The second display apparatus 101b is moved downward from the vehicle ceiling 1a to a position behind a front passenger seat (in a step S803), and then moved to a position at the right of the passenger seat 1d (in a step S804).

In an embodiment, the display apparatuses 101a and 101b may be electrically connected to a rear camera and/or a side camera attached to a rear portion and/or a side portion of the vehicle 1. Image data captured by the camera(s) may be displayed by the display apparatuses 101a and 101b. Therefore, the driver may have enhanced views of objects around the vehicle with minimum blind spots. Advantageously, safety of the vehicle 1 may be enhanced.

In an embodiment, one or more of the display apparatuses may include one or more flat panels and/or one or more transparent panels.

As described above, embodiments may provide enlarged, three-dimensional images to passengers inside a transportation device by consecutively arranging the display apparatuses. Embodiments may optimize passengers' image viewing experience by optimally sizing, positioning, and orienting display apparatuses inside a transportation device. Embodiments may display images to people positioned outside a transportation device using one or more display apparatuses positioned inside the transportation device. Embodiments may enhance safety of a transportation device by providing enhanced images related to the surroundings to the driver of the transportation device.

In an embodiment, a structure of a vehicle may structurally support a display device, thereby enhancing durability of the display device.

What is claimed is:

1. A display device comprising:
two or more display panels including a flexible substrate and a plurality of pixels formed on the flexible substrate; and
a guide member configured to guide the two or more display panels and provide mobility of the two or more display panels within a predetermined distance range.

2. The display device of claim 1, further comprising:
a housing receiving the two or more display panels and configured to support the two or more display panels outside the two or more display panels,
wherein the two or more display panels move within the guide member through the housing within a predetermined distance range.

3. The display device of claim 2, wherein:
the guide member is installed with extending in the longitudinal direction of a vehicle on a bottom surface of a vehicle ceiling, and a part of the guide member is downwardly extended from the vehicle ceiling.

4. The display device of claim 3, wherein:
the two or more display panels are installed on the bottom surface of the vehicle ceiling through the housing and the guide member so that wide surfaces of the display panels face the bottom surface of the vehicle ceiling.

5. The display device of claim 4, wherein:
the two or more display panels include:
a first display panel;
a second display panel positioned continuously with the first display panel; and
a third display panel positioned continuously with the second display panel.

6. The display device of claim 5, wherein:
a part of the guide member is vertically extended toward a rear seat space of the vehicle from the vehicle ceiling.

7. The display device of claim 6, wherein:
any one of the first display panel, the second display panel, and the third display panel is positioned in the rear seat space of the vehicle through the guide member.

8. The display device of claim 7, wherein:
two or more display panels of the first display panel, the second display panel, and the third display panel are continuously positioned in the longitudinal direction of the rear seat in the rear seat space of the vehicle.

9. The display device of claim 7, wherein:
two or more display panels of the first display panel, the second display panel, and the third display panel are rotated at 180 degrees and continuously positioned in the longitudinal direction of the rear seat in the rear seat space of the vehicle.

10. The display device of claim 5, wherein:
a part of the guide member is extended toward a rear window of the vehicle from the vehicle ceiling.

11. The display device of claim 10, wherein:
any one of the first display panel, the second display panel, and the third display panel is positioned on the surface of the rear window through the housing and the guide member so that wide surfaces of the display panels face the rear window of the vehicle ceiling.

12. The display device of claim 7, wherein:
a part of the guide member is horizontally extended toward a space at the left of a driver's seat,
any one of the first display panel, the second display panel, and the third display panel is positioned in the space at the left of a driver's seat through the guide member.

13. The display device of claim 12, wherein:
any one of the first display panel, the second display panel, and the third display panel, which is positioned in the space at the left of the driver's seat, is interlocked with a rear camera or a side camera of the vehicle.

14. The display device of claim 7, wherein:
a part of the guide member is horizontally extended toward a space at a right of a passenger seat,
any one of the first display panel, the second display panel, and the third display panel is positioned in the space at the right of a passenger seat through the guide member.

15. The display device of claim 14, wherein:
any one of the first display panel, the second display panel, and the third display panel, which is positioned in the space at the right of the passenger seat, is interlocked with a rear camera or a side camera of the vehicle.

16. The display device of claim 1, wherein:
the two or more display panels are any one of a transparent panel, a flat panel, and a flexible panel.

17. A display device comprising:
a first display apparatus;
a second display apparatus; and
a guide mechanism connected to each of the first display apparatus and the second display apparatus and configured to guide each of movement of the first display apparatus and movement of the second display apparatus.

18. A transportation device comprising:
a ceiling;
a first seat positioned below the ceiling;
a first display apparatus;
a second display apparatus; and
a guide mechanism connected to each of the first display apparatus and the second display apparatus and configured to guide movement of at least one of the first display apparatus and the second display apparatus relative to at least one of the ceiling and the first seat.

19. The transportation device of claim 18, wherein the first display apparatus is positioned on the ceiling in a first mode of the first display apparatus, wherein the first display apparatus is positioned to face a center portion of the first seat in a second mode of the first display apparatus.

20. The transportation device of claim 19, wherein the first display apparatus is positioned to face a first side portion of the first seat in a third mode of the first display apparatus, wherein the second display apparatus is positioned on the ceiling in a first mode of the second display apparatus, and wherein the second display apparatus is positioned to face a second side portion of the first seat in a second mode of the second display apparatus.

21. The transportation device of claim 20 comprising: a third display apparatus, wherein the third display apparatus is positioned on the ceiling in a first mode of the third display apparatus, and wherein the third display apparatus is positioned to face the center portion of the first seat in a second mode of the third display apparatus.

22. The transportation device of claim 18, wherein the second display apparatus is oriented at an obtuse angle with respect to the first display apparatus in a top view of the transportation device.

23. The transportation device of claim 22 comprising: a third display apparatus, wherein the third display apparatus is oriented is a mirror image of the second display apparatus with reference to the first display apparatus in a top view of the transportation device.

24. The transportation device of claim 18 comprising: a housing member that holds and directly contacts each of the first display apparatus and the second display apparatus, wherein a first portion of the housing member is slanted or perpendicular with respect to the ceiling, and wherein a second portion of the housing member is positioned on the ceiling.

25. The transportation device of claim 24, wherein the first portion of the housing member directly contacts the first display apparatus, and wherein the second portion of the housing member directly contacts the second display apparatus.

26. The transportation device of claim 24, wherein the first portion of the housing member is slanted or perpendicular with respect to the second portion of the housing member.

27. The transportation device of claim 18 comprising: a rear window, wherein the first display apparatus is positioned on the ceiling in a first mode of the first display apparatus, and wherein the first display apparatus is positioned between the first seat and the rear window in a second mode of the first display apparatus.

28. The transportation device of claim 18 comprising: a rear window, wherein the first display apparatus is positioned on the ceiling in a first mode of the first display apparatus, wherein the first seat is positioned between the first display apparatus and the rear window in a second mode of the first display apparatus, and wherein the first display apparatus is positioned between the first seat and the rear window in a third mode of the first display apparatus.

29. The transportation device of claim 18 comprising: a second seat, wherein the first display apparatus is positioned on the ceiling in a first mode of the first display apparatus, wherein the first seat is positioned between the first display apparatus and the second seat in a second mode of the first display apparatus.

30. The transportation device of claim 29, wherein the second display apparatus is positioned on the ceiling in a first mode of the second display apparatus, wherein the second seat is positioned between the second display apparatus and the first seat in a second mode of the second display apparatus.

31. A method of operating a display device, the method comprising:
moving, using a guide mechanism, a first display apparatus of the display device downward from a ceiling of a transportation device; and
positioning, using the guide mechanism, the first display apparatus of the display to face a first portion of a first seat of the transportation device, wherein the first seat of the transportation device is positioned below the ceiling of the transportation device.

32. The method of claim 31 comprising: rotating the first display apparatus after the first display apparatus has become slanted or perpendicular with respect to the ceiling.

33. The method of claim 31 comprising:
moving, using the guide mechanism, a second display apparatus of the display device downward from the ceiling of the transportation device; and
moving, using the guide mechanism, the second display apparatus of the display device sideways to face a second portion of the first seat of the transportation device.

34. The method of claim 31 comprising:
positioning, using the guide mechanism, the first display apparatus of the display device or a second display apparatus of the display device between the first seat of the transportation device and a rear window of the transportation device.

35. The method of claim 31 comprising:
moving, using the guide mechanism, one of the first display apparatus of the display device and a second display apparatus of the display device to position a second seat of the transportation device between a third seat of the transportation device and the one of the first display apparatus of the display device and the second display apparatus of the display device.
